(19) United States
(12) Patent Application Publication
(10) Pub. No.: US 2006/0016201 A1
(43) Pub. Date: Jan. 26, 2006

(54) Actuator alarm for critical environments or applications

(75) Inventor: Zev Kopel, Quebec (CA)

Correspondence Address: ROBERT C. KAIN, JR., 750 SOUTHEAST THIRD AVENUE, SUITE 100, FT LAUDERDALE, FL, 333161153, US

(73) Assignee: National Environmental Products, Ltd.

(21) Appl. No.: 11/003,591

(22) Filed: Dec. 3, 2004

Related U.S. Application Data
(60) Provisional application No. 60/589,474, filed on Jul. 20, 2004.

(51) Int. Cl. G01K 13/00

(52) U.S. Cl. 62/129

(57) ABSTRACT

The air damper or valve actuator system with an alarm includes a motor coupled to the air damper or valve, an electrical power sensor for sensing an electrical power characteristic of the motor during the motor's motive operation of the air damper or valve and a threshold sensor. The threshold sensor determines and generates an alarm signal when the power characteristic exceeds a predetermined value during the motor's motive operation. An end point sensor is utilized to detect when the motor and coupled air damper or valve reaches a mechanical operational end point thereby disabling the alarm. The method for detecting and issuing an alarm indicative of potential impending mechanical failure includes sensing the product characteristic and determining and generating an alarm when the power characteristic exceeds a predetermined value before the motor driven actuator reaches a pre-set mechanical end position. The distributed system which monitors a plurality of actuator systems via a central control station.

The present invention relates to an air damper or valve actuator system with an alarm feature and a distributed system for monitoring a plurality of such actuator systems and methods for detecting and issuing an alarm indicative of potential impending mechanical failure of the air damper or valve systems.

### BACKGROUND OF THE INVENTION

Actuators are utilized to open and close air dampers in heat, air conditioning and ventilation systems (HVAC systems) and are also used to open and close valves in hydraulic systems. These actuators customarily include motors and controllers which respond to control signals applied thereto by external master HVAC or hydraulic control centers. In most situations, air damper actuators (which control air flow through HVAC ventilation systems) and valve actuators (which control hydraulic flow through pipes and tubes) are installed and located in places which are easy to reach by installers and subsequent maintenance personnel. Therefore, potential failures of these actuators are typically not critical and the installation of these actuators and the operation of the actuators are typically not protected or fall within the scope of recommended periodic maintenance contracts and building maintenance procedures.

However, some applications which utilize of air damper actuators or valve actuators are critical in that the failure of the actuator (to open or close upon command) can create significant economic or safety repercussions. For example, when an actuator is used in an unmanned cellular telephone transfer station which is remote and moderately inaccessible during winter time (or during other adverse weather conditions), the failure of the actuator may result in a system wide failure of the cellular telephone system. In this example, the actuator is an important part of the overall temperature control and command assembly system in the unmanned station. A failure of the actuator in these unmanned cellular telephone transfer stations may deprive thousand of customers of cellular telephone service for prolonged periods of time. Therefore, the cellular service provider is both economically at risk and its reputation for high quality “always ON” cellular telephone service may be affected. Another example of a critical application of these actuators is the utilization of an air damper actuator or valve actuator in laboratory ventilation hood systems. In these hood systems, the actuator controls the air flow of contaminated air away from the operator of the hood. If the actuator fails to open or close the damper or valve (due to damper/valve failure), dire consequences may result.

It may be beneficial to predict actuator/air damper/valve failures before the actuator and mechanically driven system ceases operation. In this manner, in a distributed command and control system, the central control station can note the deteriorated or poor condition of the actuator and associated mechanical system and issue appropriate personnel commands and recommendations for the preventive maintenance of the “at risk” actuator prior to actuator failure. Actuator failure usually results due to a failure of the air damper or valve or a “locking up” of the damper or valve rather than the actuator failing to operate. In other words, the actuated component fails, not the actuator per se.

Since the actuator motors are coupled, either directly or via a gear system, to mechanically movable air dampers or valves, the air dampers or valves may become sticky and difficult to move or motivate over time. Although less likely, hydraulic valves are subject to similar deteriorating operating conditions. Time frames of 5-10 years are not unusual. Further, the grease or lubricant utilized in and on air dampers or valves may become sticky or less lubricous and the mechanical damper or valve may generate resisting torque contrary to the movement of the actuator motor. Also, the air damper and valve may oxidate (rust) over time and such oxidation further restricts the movement of the air damper or valve. It is beneficial to develop a system which monitors the operational condition of the air damper actuator or valve actuator and, hence, all mechanical systems effected thereby.

### OBJECTS OF THE INVENTION

It is an object of the present invention to provide an air damper or valve actuator system with an alarm feature for sensing indications of potential impending mechanical failure of the air damper or valve.

It is another object of the present invention to provide a distributed monitoring system for a plurality of actuators.

It is a further object of the present invention to provide an actuator system with an alarm feature which monitors an electrical power characteristic during the actuator motor's motive operation thereby triggering an alarm when a sensor exceeds a predetermined value.

It is a further object of the present invention to provide an actuator system which disables the alarm when the motor and the coupled air damper or valve reaches an operational end point (the physical limit of the air damper or valve).

### SUMMARY OF THE INVENTION

The air damper or valve actuator system with an alarm may be part of a distributed monitoring system (communicatively linked to a central control station). The actuator system includes a motor coupled to the air damper or valve, an electrical power sensor for sensing an electrical power characteristic of the motor during the motor's motive operation of the air damper or valve and a threshold sensor. The threshold sensor determines and generates an alarm signal when the power characteristic exceeds a predetermined value during the motor's motive operation. An end point sensor is utilized to detect when the motor and coupled air damper or valve reaches a mechanical operational end point thereby disabling the alarm. The method for detecting and issuing an alarm indicative of potential impending mechanical failure includes sensing the power characteristic and determining and generating an alarm when the power characteristic exceeds a predetermined value before the motor driven actuator reaches a pre-set mechanical end position. The distributed system monitors a plurality of actuator systems and utilizes a central control station. Each actuator system, as part of the distributed system, generates and transmits its respective alarm signal to the central control station when the power characteristic exceeds a predetermined value during the motor's motive operation.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates an actuator system mechanically coupled to an air damper as part of an HVAC system;

FIG. 2 diagrammatically illustrates a valve actuator coupled to a valve in a hydraulic system;

FIG. 3 is a system diagram showing a distributed system for monitoring a plurality of actuator systems;

FIG. 4 diagrammatically illustrates one embodiment of the actuator system components in a schematic format;

FIG. 5 diagrammatically illustrates another embodiment of the actuator system in schematic form;

FIG. 6 diagrammatically illustrates a sensor detecting an operational end point position of the actuator coupler (the coupler ultimately connected to an air damper or a valve); and

FIG. 7 diagrammatically illustrates an actuator deployed in a critical environment such as a laboratory ventilation hood.

### DETAILED DESCRIPTION OF THE PREFERRED EMBODIMENTS

The present invention relates to an air damper or valve actuator system with an alarm feature and a distributed system for monitoring a plurality of such actuator systems and methods for detecting and issuing alarms indicative of potential impending mechanical failure of the air damper or valve actuator systems.

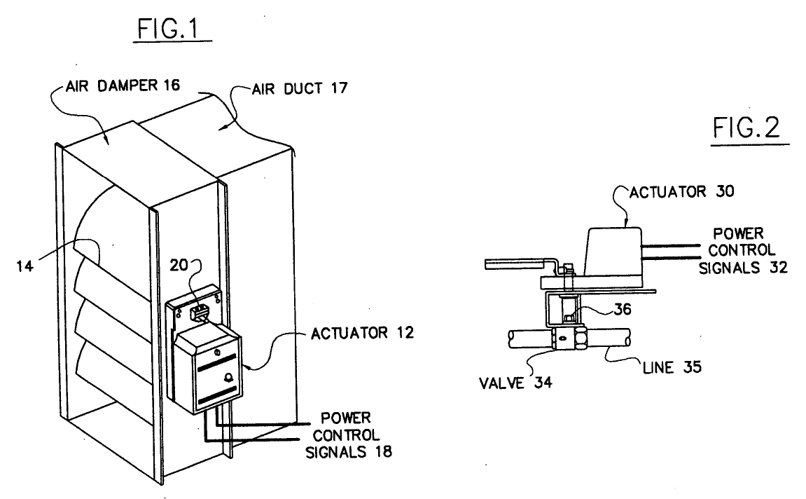

FIG. 1 diagrammatically illustrates air damper actuator 12 (which includes a motor, not shown) coupled via coupling 20 to a mechanical linkage system (not shown) permitting vanes 14 to move and open and close the air duct 17. The vanes dampen air flow through the duct. Air damper 16 is known by persons of ordinary skill in the art. Actuator 12 receives power control signals 18 from a command and control system usually located somewhere in the facility which houses the entire ventilation system, of which duct 17 is a part thereof.

FIG. 2 diagrammatically illustrates valve actuator 30 receiving power control signals 32. Actuator 30 is mechanically coupled via coupling 36 to a valve 34. Valve 34 controls fluid flow through hydraulic line 35. Sometimes air damper actuator 12 and valve actuator 30 operate in critical environments or applications such as remotely disposed mechanical facilities or in conjunction with ventilation hoods handling hazardous chemicals and biologic aerosol agents. Other critical utilizations may incorporate air damper and valve actuators.

Further details of air damper and air valve actuators are found in U.S. Pat. No. 5,278,454 to Strauss, the content of which is incorporated herein by reference thereto.

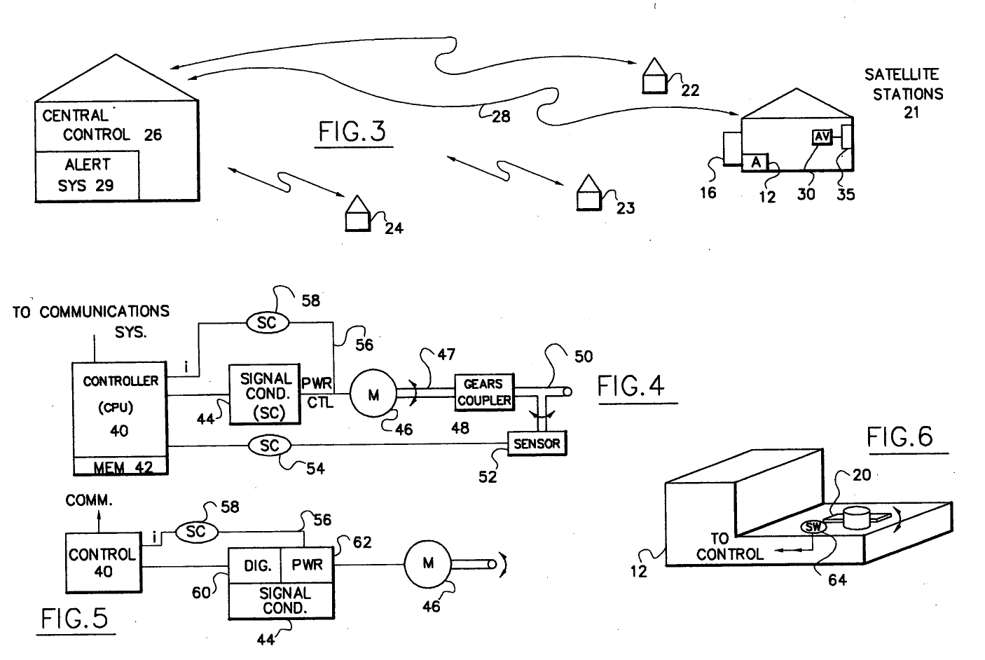

FIG. 3 diagrammatically illustrates a plurality of satellite stations 21, 22, 23 and 24 which are communicatively linked to a central control station 26. The communications system, one of which is communications link 28, may include cellular telephone networks, land-line telephone networks, wide area networks established by multiple computer-server systems; Internet communications, orbital satellite communications or any other communicative links. In any event, satellite station 21 may include air damper 16 which is opened or closed based upon mechanical actuation by actuator 12. Station 21 may include also hydraulic line 35 and an actuator valve control 30. Of course, satellite station 21 may include multiple air dampers 16 and not include valve actuator 30. Alternatively, multiple valve actuators may be deployed in any one of the satellite stations 21-24. As discussed in detail later, upon detecting an impending potential mechanical failure, air damper actuator or valve actuator 12, 30 issues an alarm signal which is transmitted via communications link 28 to central control 26. Central control 26 includes an alert system 29 which detects the alarm, identifies the particular valve or air damper actuator based upon identification data embedded in the communications data package and also identifies the particular satellite station which generated the alarm signal (also an embedded data signal). Alert system 29 then generates some type of supplemental alert which indicates to the operators at central control 26 that the air damper actuator or valve actuator is subject to potential impending mechanical failure. This results in the operators of central control 26 issuing preventive maintenance orders such that the air damper actuator or air damper or valve actuator or valve be replaced or maintained or cleaned to reduce or eliminate the potential impending mechanical failure.

FIG. 4 diagrammatically illustrates one embodiment of the alarmed air damper or valve actuator system. In the illustrated embodiment, controller 40, which may be a digital control CPU or a programmable controller (a programmable IC), includes a memory sub-system 42. Controller 40 accepts power control signals 18, 32 (not shown in FIG. 4) from an exterior source and ultimately generates control signals which are supplied to signal conditioner SC 44. Signal conditioner 44 converts the control signal from controller 40 into an appropriate power control signal which is supplied to motor M 46. The mechanical output of motor 46 is typically applied to a gear system or at least applied to a coupler 48. The output of coupler 48 is relayed to mechanical output element 50 which is ultimately mechanically connected to vanes 14 of air damper 16 in FIG. 1 or to valve 34 illustrated in FIG. 2. In the illustrated embodiment, mechanical output element 50 is connected to a sensor 52 which generates a signal representative of the movement of mechanical element 50. This representative movement signal (establishing the motive operation of the actuator motor) is applied to signal conditioner 54 and is ultimately applied to controller 40.

The power or control signal supplied to motor 46 is monitored by feedback monitor line 56. Signal conditioner 58 changes and modifies the monitor signal, representative of an electrical power characteristic of motor 46, and the resulting signal is applied to controller 40. In a preferred embodiment, the current supplied to motor 46, represented by current symbol i, is monitored by controller 40.

It should be appreciated that although a digital system is discussed herein in connection with controller 40, persons of ordinary skill in the art could produce an analog system having the same operational characteristics and functional elements as described in conjunction with the controllers illustrated in FIGS. 4 and 5.

In operation, controller 40 receives control signal from another command and control module (not shown) as is known to persons of ordinary skill in the art. Upon receiving the appropriate power, command and control signal, controller 40 issues an appropriate power control to signal conditioner 44. Signal conditioner 44 in a digital environment converts the digital power control signal into a generally analog power control signal and that signal is applied to the input of motor 46. Motor 46 is then turned ON and the motor motivates or moves output shaft 47 and gear or coupler system 48 and mechanical output 50 and ultimately vanes 14 in air damper 16 or valve 34 associated with hydraulic line 35. Sensor 52, mechanically attached to mechanical output element 50, senses the movement of element 50, and generates a signal ultimately passing through conditioner 54 and to controller 40. At the same time (or relatively the same time), controller 40 monitors an electrical power characteristic, typically current i, applied to motor 46 based upon feedback monitor line 56. It is well known that, with respect to DC motors (typically utilized in air damper actuators and valve actuators), when the motors stop rotating due to excessive counter rotational torque applied to output elements 47,50, the power consumption of the motor, particularly current i, increases. This increase is sensed by controller 40 as captured by feedback monitor line 56. When the motor stops due to excessive counter rotational torque caused by the sticky damper or valve, the motor is placed in a “stall” condition. In a stall condition, the current i consumption of a motor greatly increases. Various electrical characteristics of the motor may be monitored to detect such stall condition.

Typically during normal operation, at maximum load, motor 46, as an example, may utilize 35 ma. Other motors use different amounts of current and are subject to different threshold levels. In a stalled condition, the typical 35 ma motor may utilize or draw 150 ma (a measure of current i). Further, it is typical that these types of motors may include an electronic or electrical control limiter which limits the supply current to a certain maximum value. As an example, 85 ma may be the maximum input current permitted by the electric control limit system. Since it is known that when the motor comes close to a stall condition, current consumption greatly increases, controller 40 includes a threshold sensing circuit or program function monitoring the feedback current i from line 56 such that when the current exceeds, in the example discussed herein, 75 ma, an alarm signal is generated. Upon detection of the alarm signal and if sensor 52 is still detecting rotational movement on mechanical output element 50 (the motor's motive operation), control 40 issues an alarm signal which is sent to the communication system. Controller 40 may supply an alarm signal to another transmitter and the transmitter may utilize communications link or channel 28 (FIG. 3) to communicate with central control 26. Alternatively, the alarm signal could be stored in the local command and control system and satellite station 21 and then, upon batch processing of data (that data) indicating the particular actuator subject to the impending mechanical failure alarm plus a data representing the satellite station plus any other additional operating data from the satellite station) may be transmitted in a batch communication session to central control 26. Central control 26 decodes this batch communication, identifies the particular satellite station subject to the alarm, identifies the particular actuator subject to the alarm and generates the appropriate preventive maintenance report. The preventive maintenance report is delivered to personnel who place the satellite station and the particular actuator on a preventive maintenance list which, in the near future, results in service to the particular air damper or valve that is subject to the potential impending mechanical failure. Such service may include cleaning, repair, replacement or readjustment of the air damper, the valve or the actuator. Alternatively, memory 42 may store the impending failure signal and, when polled by a local unit in the satellite station 21, may upload this impending failure signal to station 26.

Memory 42 is utilized to store data, such as actuator id data, and particularly the predetermined threshold value which triggers the alarm signal. The threshold value at which an alarm is generated may be pre-set by the factory or may be set by the installer. Typically, factory settings are utilized.

The term “impending failure” is used because it is believed that the excessive feedback power signal will be indicative of a soon to fail mechanical system. However, at a minimum, the alarm system senses a failed damper or valve (one that refuses to open or close to the pre-set position).

Sensor 52 in a preferred embodiment is a potentiometer or variable resistor that outputs a variable electrical signal based upon rotational movement of mechanical output element 50 coupled thereto. Other types of sensors sensing rotational movement may be utilized. Also, sensor 50 could be connected directly to the output shaft 47 of motor 46. Further, sensor 52 could be located anywhere along the drive chain from motor 46, shaft 47, gear or coupler 48 and mechanical output element 50. Other types of sensors could be utilized.

The reason for utilizing sensor 52 or any other type of operational end point position sensor is as follows. Motor 46 generally drives the output system 47, 48, 50 and ultimately air damper 16 or valve 34 to a mechanical end point (either full open or full close or some other mechanically set position). Motor 46 continues to drive the system even beyond the mechanical end point reached by air damper 16 and valve 34, generally as a safety factor (the overdrive is a safety factor). Hence, when the air damper or valve reaches its mechanical end point position, motor 46 is still running. The motor then transitions into a stall condition (or near stall condition) and current on the power control line increases as is common in a stall condition. Control 40 must be able to discern or determine when motor 46 has driven the air damper or valve to its required end point position in contrast to a stall condition when the motor is attempting to move or motivate the air damper at an intermediate position. At intermediate positions, the motor is positively driving or operating the air damper or valve. Since these air dampers or valves are customarily located in remote locations either in large buildings or hidden under ventilation chemical hoods or in satellite stations remote from central control positions, the air dampers and valves or not regularly cleaned and relubricated. Therefore, the air dampers tend to get sticky and may ultimately not open or not close as designed by the engineer. The same is true regarding valves. Therefore, since the actuator motors drive the air dampers and the valves beyond the standard or pre-set mechanical end point, control 40 has to determine when the actuators reach the pre-set mechanical end point as distinct from the stall condition obtained when the actuator is in a potential impending mechanical failure mode. In other words, the stall condition during impending potential mechanical failure occurs prior to the time that sensor 52 senses the end position by the mechanical limits of the air damper or valve.

If sensor 52 is still moving (in a motive operation), as shown by the changing electrical condition (voltage, current or resistance) on the feedback line fed through signal conditioner 54, and the current i monitored by feedback monitor line 56 exceeds the alarm trigger threshold, and control 40 issues an alarm signal. If the position sensor 52 indicates no movement and, thereafter, current i from feedback line 56 approaches and exceeds alarm trigger threshold, the alarm is disabled (or the controller ignores the alarm (end position sensor overrides alarm)) because controller 40 has detected that mechanical output element 50 is at the mechanical limit for the air damper or valve actuator.

It is possible, although not recommended, that a timer may be utilized by control 40 rather than a position sensor 52. The timer will time the amount of time necessary to close the air damper or valve. Excessive feedback signals within the time cause an alarm whereas signals outside the time frame are ignored. Further, sensor 52 can be mechanically coupled to mechanical output element 50 or can optically sense the rotational movement of element 50 or utilize other type of electronic sensor system such as tachometers, accelerometers or items that have electromagnetic sensors. Further, an electromagnetic sensor may be attached or mounted to motor 46 to detect when the rotor of motor 46 stops movement. Memory 42 includes data specifically identifying the actuator and such data is attached or bundled with the alarm signal and sent to systems and communications link 28. Controller 40 has programming elements or routines which carry out the functional tests outlined herein.

If the actuator control system in FIG. 4 is configured as an analog system, signal conditioners 44, 54 and 58 may simply change the control signal into an appropriate value (for example, voltage into current) utilized by the analog controller 40 and the motor. Although memory 42 may be included in an analog version of controller 40, the memory setting for the threshold value would simply be established by a resistance or a limit current or voltage sensor on an analog basis.

FIG. 5 diagrammatically illustrates another embodiment of the actuator controller. Controller 40 outputs a digital signal in FIG. 5 and signal conditioner 44 includes a digital component unit 60 which is coupled, typically through optoelectrical transistors, to an analog power component unit 62. Motor 46 is connected to analog power unit 62 in signal conditioner 44. Monitor feedback line 56 is coupled to the analog power component unit 62. One important feature of the present invention is that an electrical power characteristic of motor 46 is monitored and such monitoring occurs on or with respect to a power input ultimately supplied to motor 46.

FIG. 6 diagrammatically illustrates actuator 12 and coupler 20 with a position sensor switch SW 64. Position sensor switch SW 64 is a sensor detecting a physical operational end point position of coupler 20. The output of switch 64 is applied to controller 40 as discussed earlier in connection with FIGS. 4 and 5. When coupling 20 reaches a certain arcuate position, switch SW changes state OFF/ON.

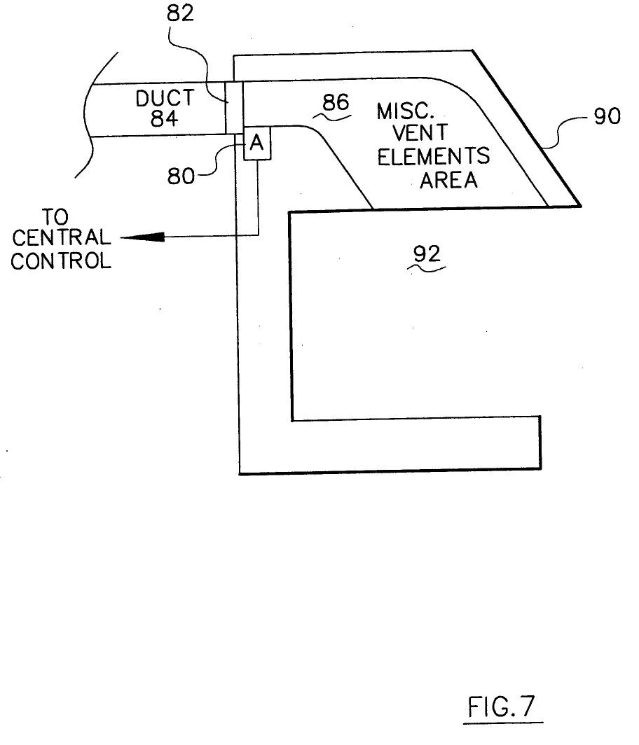

FIG. 7 diagrammatically illustrates a critical application of actuator 80. In the illustrated embodiment, actuator 80 opens and closes air damper 82 (or position it to a pre-set location) which damper is intermediate duct 84 and miscellaneous vent elements area 86. Hood system 90 is utilized by its operators such that noxious or hazardous fumes are controlled within hood area 92. Various other vent elements, such as sprayers, fans, vanes and vents may be positioned in elements area 86. Actuator 80, upon issuance of the alarm as explained above in connection with FIGS. 4, 5, sends the alarm to a central control unit in the event of impending mechanical failure. This alerts the operators and the monitoring personnel at central control of an impeding mechanical failure or the possibility thereof at actuator 80. Further, the alarm may be issued to the operator utilizing hood 90. This local alarm may require the operator to stop using the hood. Of course, hood 90 may use an alarmed valve actuator.

The claims appended hereto are meant to cover modifications and changes within the scope and spirit of the present invention.

What is claimed is:

1. An air damper or valve actuator system with an alarm feature comprising:
a motor coupled to said air damper or said valve;
an electrical power sensor for sensing an electrical power characteristic of said motor during said motor's motive operation of said air damper or valve;
threshold sensor, coupled to said power sensor, to determine and generate an alarm signal when said electrical power characteristic of said motor exceeds a predetermined value during said motor's motive operation.

2. An actuator system as claimed in claim 1 including a communications link to transmit said alarm outboard of said air damper or valve actuator system.

3. An actuator system as claimed in claim 1 wherein said electrical power characteristic is one of operating current or voltage applied to said motor during said motor operation.

4. An actuator system as claimed in claim 1 including a communications sub-system, coupled to said threshold sensor, for transmitting a representative signal, corresponding to said alarm signal, outboard said actuator to another extraneous control system.

5. An actuator system as claimed in claim 1 wherein said power sensor measures current supplied to said motor during said motor's operation.

6. An actuator system as claimed in claim 1 including an end position sensor to detect when said motor and coupled air damper or valve reaches an operational end point.

7. An actuator system as claimed in claim 6 wherein said end position sensor is one of a sensor monitoring a motor mechanical output and a sensor detecting an operational end point position.

8. An actuator system as claimed in claim 1 including a controller for controlling said motor and said motor's operation, said controller including a digital control sub-system and a power delivery control sub-system, said power delivery sub-system coupled to said motor.

9. An actuator system as claimed in claim 8 wherein said electrical power sensor is coupled to said power delivery control sub-system enabling sensing of said electrical power characteristic of said motor during said motor's operation.

10. An actuator system as claimed in claim 8 wherein said motor has a power supply line and said electrical power sensor is coupled to said power supply line.

11. An actuator system with an alarm feature in communication with a central control station, said actuator system driving an air damper actuator or a valve actuator, said actuator system remotely disposed with respect to said central control station, said actuator system comprising:
a motor coupled to said air damper or said valve;
an electrical power sensor for sensing an electrical power characteristic of said motor during said motor's motive operation of said air damper or valve;
threshold sensor, coupled to said power sensor, to determine, generate and transmit an alarm signal to said central control station when said electrical power characteristic of said motor exceeds a predetermined value during said motor's motive operation.

12. An actuator system as claimed in claim 11 including a communications link to transmit said alarm outboard of said air damper or valve actuator system.

13. An actuator system as claimed in claim 11 wherein said electrical power characteristic is one of operating current or voltage applied to said motor during said motor operation.

14. An actuator system as claimed in claim 11 including a communications sub-system, coupled to said threshold sensor, for transmitting a representative signal, corresponding to said alarm signal, outboard said actuator to another extraneous control system.

15. An actuator system as claimed in claim 11 wherein said power sensor measures current supplied to said motor during said motor's operation.

16. An actuator system as claimed in claim 11 including an end position sensor to detect when said motor and coupled air damper or valve reaches an operational end point.

17. An actuator system as claimed in claim 16 wherein said end position sensor is one of a sensor monitoring a motor mechanical output and a sensor detecting an operational end point position.

18. An actuator system as claimed in claim 11 including a controller for controlling said motor and said motor's operation, said controller including a digital control sub-system and a power delivery control sub-system, said power delivery sub-system coupled to said motor.

19. An actuator system as claimed in claim 18 wherein said electrical power sensor is coupled to said power delivery control sub-system enabling sensing of said electrical power characteristic of said motor during said motor's operation.

20. An actuator system as claimed in claim 18 wherein said motor has a power supply line and said electrical power sensor is coupled to said power supply line.

21. An actuator system as claimed in claim 11 wherein said threshold sensor transmits said alarm signal after determining when said electrical power characteristic of said motor exceeds a predetermined value during said motor's motive operation.

22. A method for detecting and issuing an alarm indicative of potential impending mechanical failure of an air damper or valve actuator system which includes a motor driving said air damper or valve and supplied with electrical power, the method comprising:
sensing an electrical power characteristic of said motor during said motor's operation;
determining and generating an alarm signal when said electrical power characteristic of said motor exceeds a predetermined value before said motor driven actuator reaches a pre-set mechanical end position.

23. A method as claimed in claim 22 including sensing when said motor driven actuator reaches a pre-set mechanical end position and disabling said determining and generating an alarm signal.

24. A distributed system for monitoring a plurality of actuator systems, each actuator system driving an air damper actuator or a valve actuator, said distributed monitored system comprising:
a central control station remotely disposed with respect to said plurality of actuator system;
each said actuator system having:
a motor coupled to said air damper or said valve;
an electrical power sensor for sensing an electrical power characteristic of said motor during said motor's motive operation of said air damper or valve;
threshold sensor, coupled to said power sensor, to determine, generate and transmit an alarm signal to said central control station when said electrical power characteristic of said motor exceeds a predetermined value during said motor's motive operation.

25. A distributed monitored system as claimed in claim 24 wherein each actuator system includes a communications link to transmit said alarm outboard of said air damper or valve actuator system.

26. A distributed monitored system as claimed in claim 24 wherein in each actuator system, said electrical power characteristic is one of operating current or voltage applied to said motor during said motor operation.

27. A distributed monitored system as claimed in claim 24 wherein each actuator system includes a communications sub-system, coupled to said threshold sensor, for transmitting a representative signal, corresponding to said alarm signal, outboard said actuator to another extraneous control system.

28. A distributed monitored system as claimed in claim 24 wherein in each actuator system, said power sensor measures current supplied to said motor during said motor's operation.

29. A distributed monitored system as claimed in claim 24 wherein each actuator system includes an end position sensor to detect when said motor and coupled air damper or valve reaches an operational end point.

30. A distributed monitored system as claimed in claim 29 wherein in each actuator system, said end position sensor is one of a sensor monitoring a motor mechanical output and a sensor detecting an operational end point position.

31. A distributed monitored system as claimed in claim 24 wherein each actuator system includes a controller for controlling said motor and said motor's operation, said controller including a digital control sub-system and a power delivery control sub-system, said power delivery sub-system coupled to said motor.

32. A distributed monitored system as claimed in claim 31 wherein in each actuator system, said electrical power sensor is coupled to said power delivery control sub-system enabling sensing of said electrical power characteristic of said motor during said motor's operation.

33. A distributed monitored system as claimed in claim 31 wherein in each actuator system, said motor has a power supply line and said electrical power sensor is coupled to said power supply line.

34. A distributed monitored system as claimed in claim 24 wherein in each actuator system, said threshold sensor transmits said alarm signal after determining when said electrical power characteristic of said motor exceeds a predetermined value during said motor's motive operation.
